(19) United States
(12) Patent Application Publication
(10) Pub. No.: US 2019/0212425 A1
(43) Pub. Date: Jul. 11, 2019

(54) SYSTEM AND METHOD FOR COMMUNICATING WITH A VEHICLE

(71) Applicant: Huf North America Automotive Parts Manufacturing Corp., Milwaukee, WI (US)

(72) Inventor: Antonio Odejerte, Jr., Farmington Hills, MI (US)

(21) Appl. No.: 16/093,164

(22) PCT Filed: Apr. 4, 2017
(86) PCT No.: PCT/US2017/027665

§ 371 Date: Oct. 12, 2018

Related U.S. Application Data
(60) Provisional application No. 62/323,318, filed on Apr. 15, 2016.

(51) Int. Cl. G01S 11/06

(52) U.S. Cl. CPC G01S 11/06

(57) ABSTRACT

A method is provided and includes determining a first received signal strength indicator value, determining a second received signal strength indicator value, and determining a third received signal strength indicator value. The method additionally includes determining a first difference between the first received signal strength indicator value and the second received signal strength indicator value, determining a second difference between the first received signal strength indicator value and the third received signal strength indicator value, and transmitting a signal based on the first difference and the second difference.

### CROSS REFERENCE TO RELATED APPLICATION

This application is the national phase of International Patent Application No. PCT/US2017/027665, filed Apr. 14, 2017 which claims priority to U.S. Provisional Patent Application No. 62/323,318, filed Apr. 15, 2016, the disclosures of which are hereby incorporated by reference in their entirety.

### FIELD

The present disclosure relates generally to a system and method for communicating with a vehicle, and more particularly to a system and method for determining a location of a vehicle access device relative to a vehicle.

### BACKGROUND

This section provides background information related to the present disclosure and is not necessarily prior art.

A wireless communication device, such as a key fob, a smartphone, a smart watch, or a computer (e.g., a tablet, laptop, personal digital assistant, etc.), for example, can be used to communicate with a motor vehicle. For example, a wireless communication device can communicate with a vehicle in order to access, diagnose faults, start/stop, and/or provide power to certain components and/or systems within the vehicle. In particular, a user may utilize a wireless communication protocol (e.g., short-range radio wave communication, Wi-Fi, BLUETOOTH®, near field communication (NFC), etc.) to access and/or operate the vehicle. In this regard, the operator may access and/or operate the vehicle by utilizing a wireless communication protocol controlled and powered by a smartphone.

While known systems and methods for communicating between a wireless communication device and a vehicle have proven acceptable for their intended use, such systems may be susceptible to undesirable operating characteristics.

### SUMMARY

This section provides a general summary of the disclosure, and is not a comprehensive disclosure of its full scope or all of its features.

In one configuration, the present disclosure provides a method including determining a first received signal strength indicator value, determining a second received signal strength indicator value, and determining a third received signal strength indicator value. The method additionally includes determining a first difference between the first received signal strength indicator value and the second received signal strength indicator value, determining a second difference between the first received signal strength indicator value and the third received signal strength indicator value, and transmitting a signal based on the first difference and the second difference.

The first received signal strength indicator value may correspond to a vehicle access device. The second received signal strength indicator value may correspond to a vehicle. The third received signal strength indicator value may correspond to the vehicle access device.

Determining the first received signal strength indicator value may include determining the first received signal strength indicator value at a first antenna. Determining the third received signal strength indicator value may include determining the third received signal strength indicator value at a second antenna. The first antenna may face a first direction and the second antenna may face a second direction transverse to the first direction. In one configuration, the first direction is opposite the second direction. The first antenna may include a directional antenna.

In one configuration, at least one of the first, second, and third received signal strength indicator values corresponds to a BLUETOOTH® low energy signal.

A wireless communication node for a vehicle is also provided and includes a substrate having a first side and a second side opposite the first side. A first ground plane is disposed on the first side, a second ground plane is disposed on the second side, a first antenna is coupled to the first ground plane and is operable to produce a first radiation pattern, and a second antenna is coupled to the second ground plane and is operable to produce a second radiation pattern.

The first radiation pattern may correspond to a wireless signal selected from the group consisting of a BLUETOOTH® low energy signal, a WiFi signal, and a Long-Term Evolution signal. The first radiation pattern may be operable to face an exterior portion of the vehicle and the second radiation pattern may be operable to face an interior portion of the vehicle. In one configuration, the first antenna includes a directional antenna and the second antenna includes a directional antenna.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a functional block diagram of an example vehicle communication system according to the present disclosure;

FIG. 2 is another functional block diagram of the example vehicle communication system of FIG. 1;

FIG. 3A is a side view of a communication node of the vehicle communication system of FIG. 1;

FIG. 3B is a side view of another communication node of the vehicle communication system of FIG. 1;

FIGS. 4A-4B depict a flowchart illustrating an example method of controlling a vehicle communication system according to the present disclosure; and

FIG. 5 is a flowchart depicting another example method of controlling a vehicle communication system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The description provided herein is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

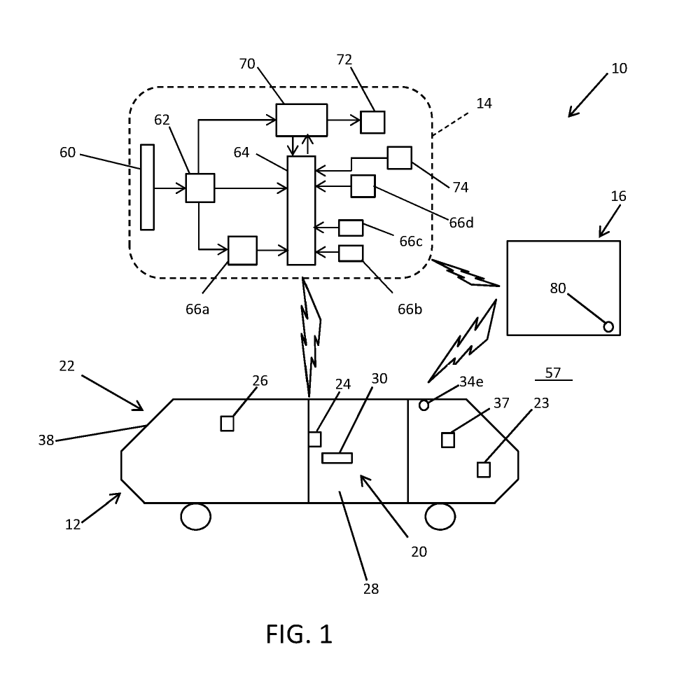

With reference to FIG. 1, a vehicle communication system 10 is provided. The vehicle communication system 10 may include a vehicle 12, at least one vehicle access device 14, and at least one control center 16. The vehicle 12 may be any known variety of motorized vehicle, such as a car, truck, or van, for example. In this regard, the vehicle 12 may be a private or commercial-type motor vehicle. In some configurations, the vehicle 12 may be one of a group of vehicles 12 that make up part of a fleet of vehicles, such as a fleet of rental vehicles or a fleet of commercial vehicles, such as delivery vehicles or service vehicles.

The vehicle 12 may include an access system 20, a communication system 22, and one or more control modules 23 (e.g., a body control module, an engine control module, a transmission control module, etc.). The access system 20 may include one or more locks 24, a lock control module 26, and one or more doors 28 and/or other access location(s). The locks 24 may permit and/or prevent access to the vehicle 12 through the doors 28. For example, each door 28 of the vehicle 12 may include a lock 24 and a handle 30. The lock control module 26 may communicate with the lock(s) 24 to permit and/or prevent operation of the handle 30 in order to permit and/or prevent access to the vehicle 12 through the doors 28. In this regard, the lock control module 26 may receive a signal from the vehicle access device 14 and control a state (e.g., locked or unlocked) of the lock(s) 24 based on the signal(s) received from the vehicle access device 14.

The communication system 22 may include one or more communication nodes 34, 34a-n and an infotainment system 37. For example, in some configurations, the communication system 22 includes five communication nodes 34, 34a-n. In particular, the communication system 22 may include a first communication node 34a, a second communication node 34b, a third communication node 34c, a wireless fourth communication node 34d, and a fifth communication node 34d. As will be explained in more detail below, the communication nodes 34, 34a-n may be configured to wirelessly communicate with the vehicle access device 14 and other portions of the vehicle 12 (e.g., the access system 20, the communication system 22, and/or the control module(s) 23) through one or more wireless communication protocols, short-range radio wave communication, Wi-Fi, BLUETOOTH®, and/or BLUETOOTH® low energy (BLE) (e.g., Mesh BLE or scatternet BLE).

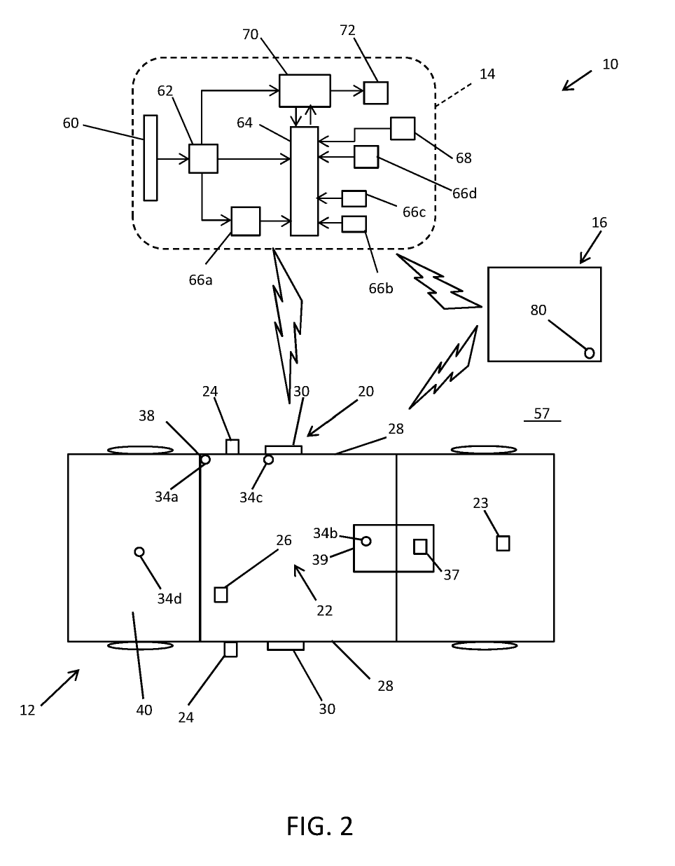

As illustrated in FIGS. 1 and 2, the communication nodes 34, 34a-n may be located in various locations on and/or in the vehicle 12. For example, the first communication node 34a may be located on a body portion of the vehicle 12. In particular, in some configurations, the first communication node 34a may be located on a C-pillar 38 of the vehicle 12. In some implementations, the first communication node 34a may be configured to communicate with the vehicle access device 14 and other portions of the vehicle 12 (e.g., the access system 20, the communication system 22, and/or the control module(s) 23). In particular, the first communication node 34a may be configured to communicate with the vehicle access device 14 through a long-range wireless communication protocol (e.g., WIFI, LTE, a long range wide area network, SigFox, etc.). The first communication node 34a may be configured to communicate with other portions of the vehicle 12 through a wired communication protocol (e.g., CAN, LIN, and/or K-Line).

The second communication node 34b may be located proximate the center of the vehicle 12. For example, the second communication node 34b may be located proximate a center console 39 of the vehicle 12. In some implementations, the second communication node 34b may be configured to communicate with the vehicle access device 14 and other portions of the vehicle 12 (e.g., the access system 20, the communication system 22, and/or the control module(s) 23). In particular, as will be explained in more detail below, the second communication node 34b may be utilized in a localization method. Namely, the second communication node 34b may determine a location of the vehicle access device 14. For example, the second communication node 34b may be configured to determine whether the vehicle access device 14 is located inside the vehicle 12 or outside of the vehicle 12.

The third communication node 34c may be located on one of the doors 28 of the vehicle 12. For example, in some configurations the third communication node 34c may be located proximate to the door handle 30 on a driver's side of the vehicle 12. In some implementations, the third communication node 34c may be configured to communicate with the vehicle access device 14 and other portions of the vehicle 12 (e.g., the access system 20, the communication system 22, and/or the control module(s) 23). In particular, as will be explained in more detail below, the third communication node 34c may be utilized in a localization method. Namely, the third communication node 34c may determine a location of the vehicle access device 14. For example, the third communication node 34c may be configured to determine whether the vehicle access device 14 is located inside the vehicle 12 or outside of the vehicle 12.

The fourth communication node 34d may be located proximate a rear portion of the vehicle 12. For example, as illustrated in FIG. 2, the fourth communication node 34d may be located proximate to a trunk portion 40 of the vehicle 12. In some implementations, the fourth communication node 34d may be configured to communicate with the vehicle access device 14 and other portions of the vehicle 12 (e.g., the access system 20, the communication system 22, and/or the control module(s) 23). In particular, as will be explained in more detail below, the fourth communication node 34d may be utilized in a localization method. Namely, the fourth communication node 34d may determine whether the vehicle access device 14 is located proximate to the trunk portion 40 of the vehicle 12.

As will be explained in more detail below, each communication node 34, 34a-n may be configured to communicate with the other wireless communication node(s) 34 and/or the vehicle access device 14. For example, the communication nodes 34, 34a-n may communicate with one another, and with the vehicle access device 14, through one or more wired and/or wireless communication protocols, such as LIN Communication, CAN-FD communication, K-Line communication, short-range radio wave communication, Wi-Fi, BLUETOOTH®, and/or BLUETOOTH® low energy (BLE) (e.g., Mesh BLE or scatternet BLE). In some implementations, the first, second, third, and fourth communication nodes 34a, 34b, 34c, 34d may be BLE nodes, and the fifth communication node 34e may be a low-frequency (LF) node. In this regard, the first, second, third, and fourth communication nodes 34a, 34b, 34c, 34d may be referred to herein as BLE communication nodes 34a, 34b, 34c, and/or 34d, and the fifth communication node 34e may be referred to herein as an LF communication node.

In some configurations, the first BLE communication node 34a may be assigned as a main or primary communication node 34a having a major BLE address. The primary communication node 34a may be responsible for long-range communication between the vehicle access device 14 and the vehicle 12. In particular, the primary communication node 34a may be responsible for communicating with the vehicle access device 14 when the distance between the vehicle access device 14 and the vehicle 12 is greater than a predetermined distance (e.g., approximately two meters). In some implementations, the primary communication node 34a may be responsible for communicating with the vehicle access device 14 when the distance between the vehicle access device 14 and the vehicle 12 is greater than approximately five meters. In some implementations, the first BLE communication node 34a may detect the presence of the vehicle access device 14. For example, the first BLE communication node 34a may detect the presence of the vehicle access device 14 when the distance between the vehicle access device 14 and the vehicle 12 is greater than the predetermined distance.

The second, third, and fourth BLE communication nodes 34b, 34c, 34d may be assigned as secondary BLE communication nodes 34b, 34c, 34d, each having a minor BLE address. The minor BLE address of the secondary BLE communication node 34b may be different than the minor BLE address of each of the third and fourth BLE communication nodes 34c, 34d. Accordingly, the minor BLE addresses can allow the secondary BLE communication nodes 34b, 34c, 34d to be differentiated from each other and from the primary BLE communication node 34a, which can help the vehicle access device 14 to determine which of the BLE communication nodes 34a, 34b, 34c, 34d to communicate with when there is more than one vehicle 12. In particular, the vehicle access device 14 may include a table that groups the BLE communication nodes 34a, 34b, 34c on a specific vehicle 12, such that using the BLE addresses, including the minor BLE addresses, can help the vehicle access device 14 to determine which of the BLE communication nodes 34a, 34b, 34c, 34d the vehicle access device 14 should communicate with when there is more than one vehicle 12.

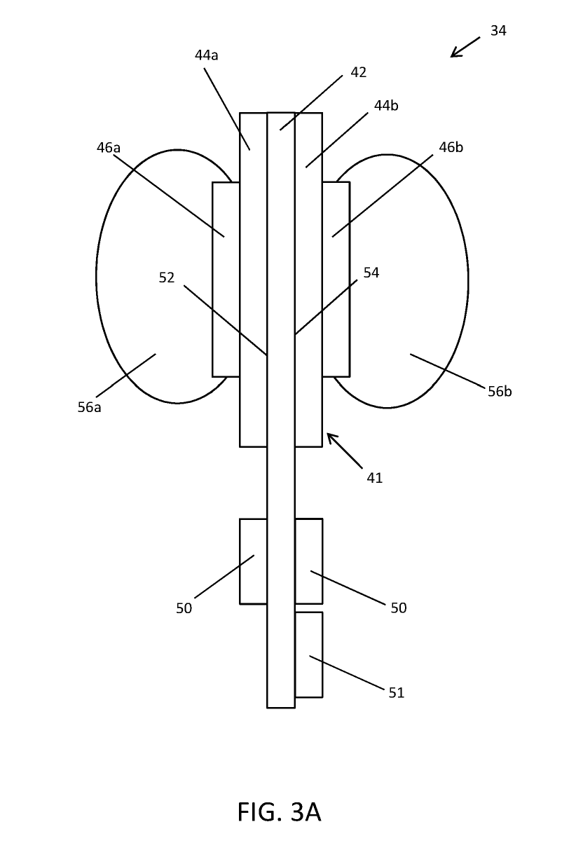

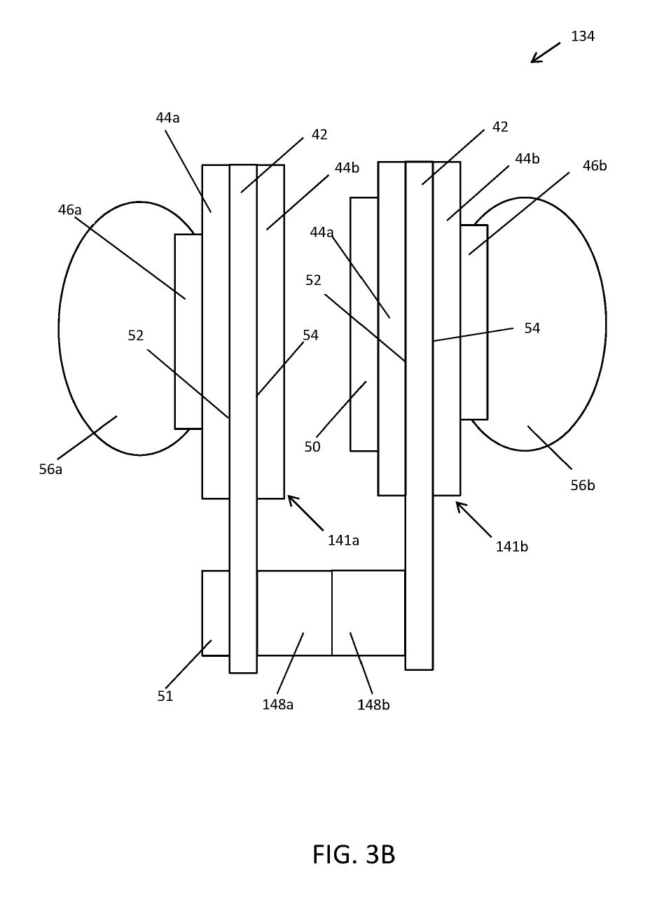

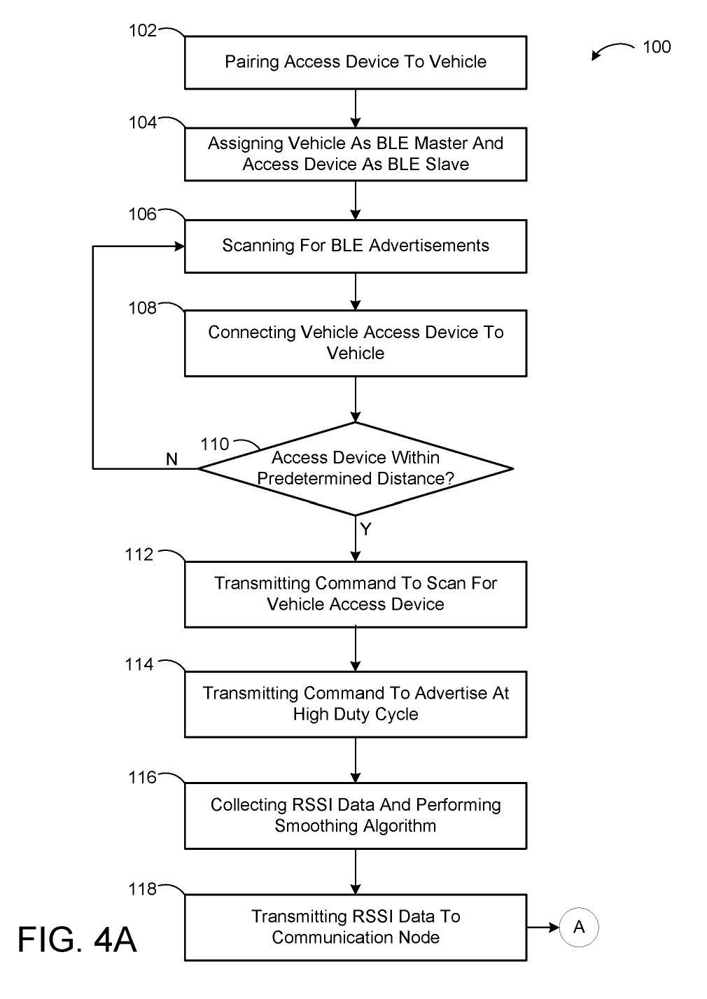

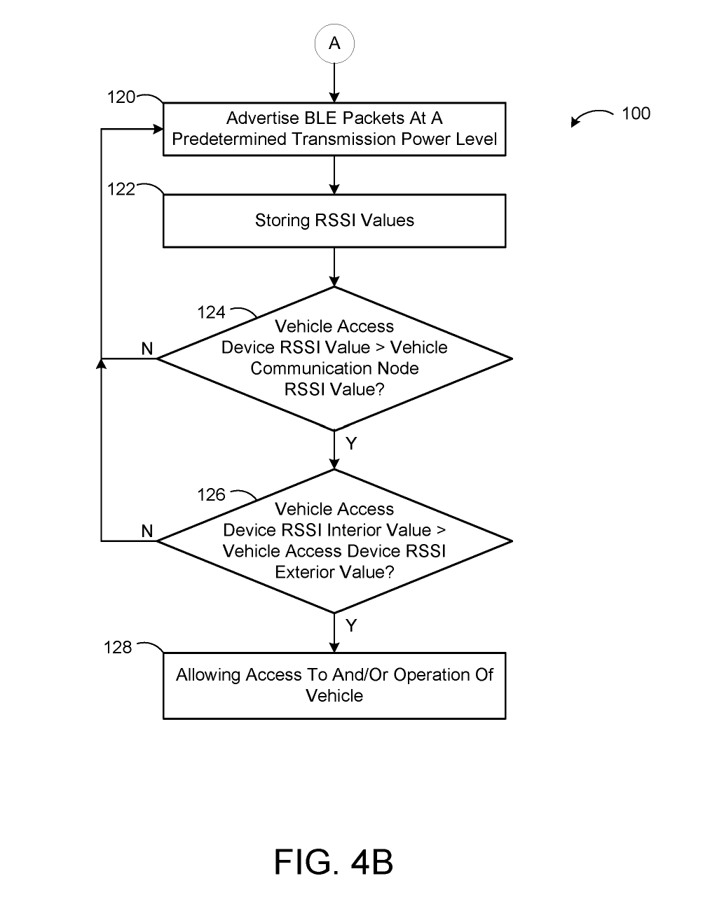

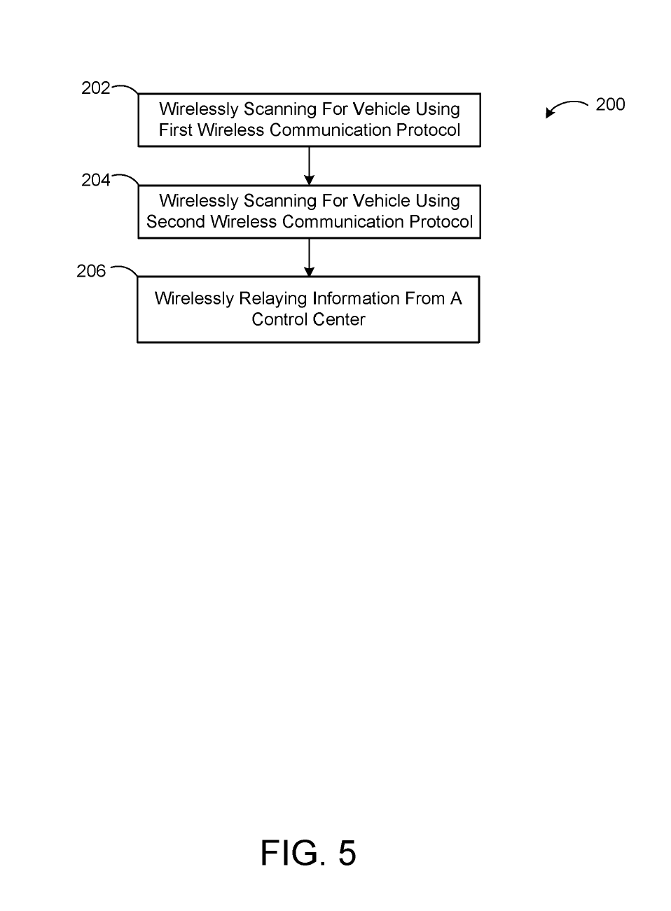

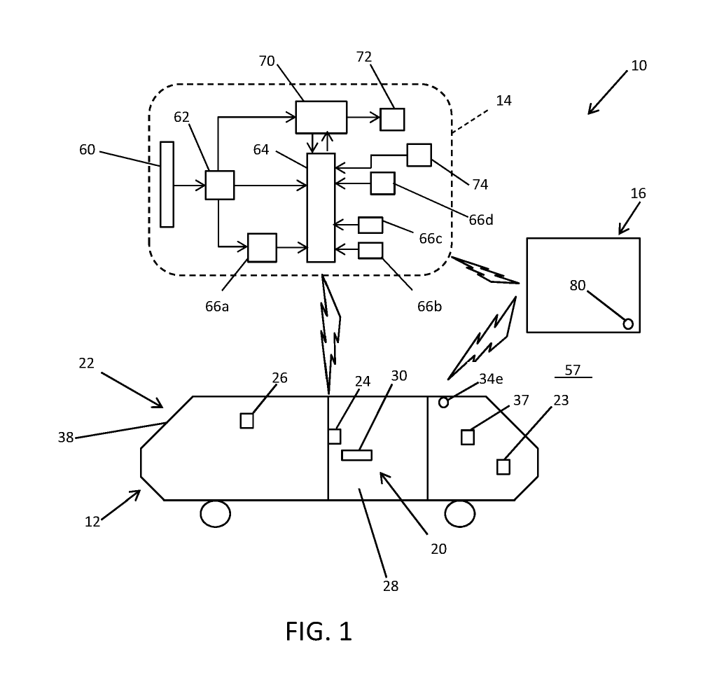

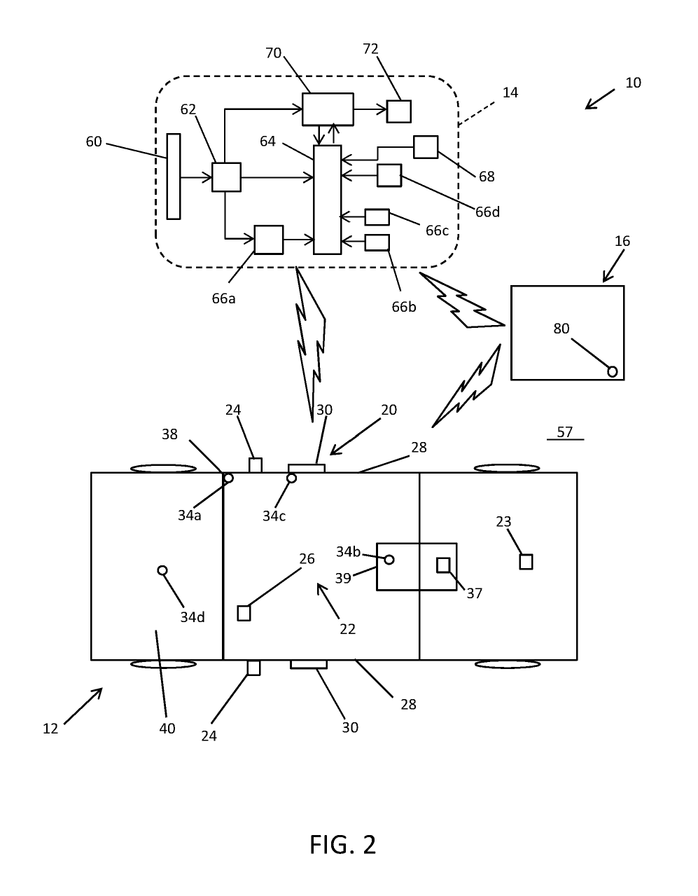

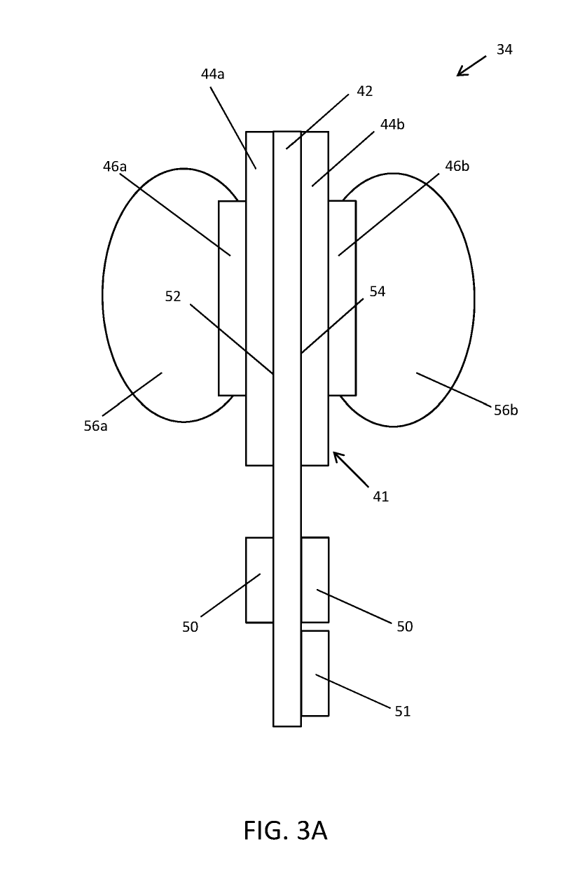

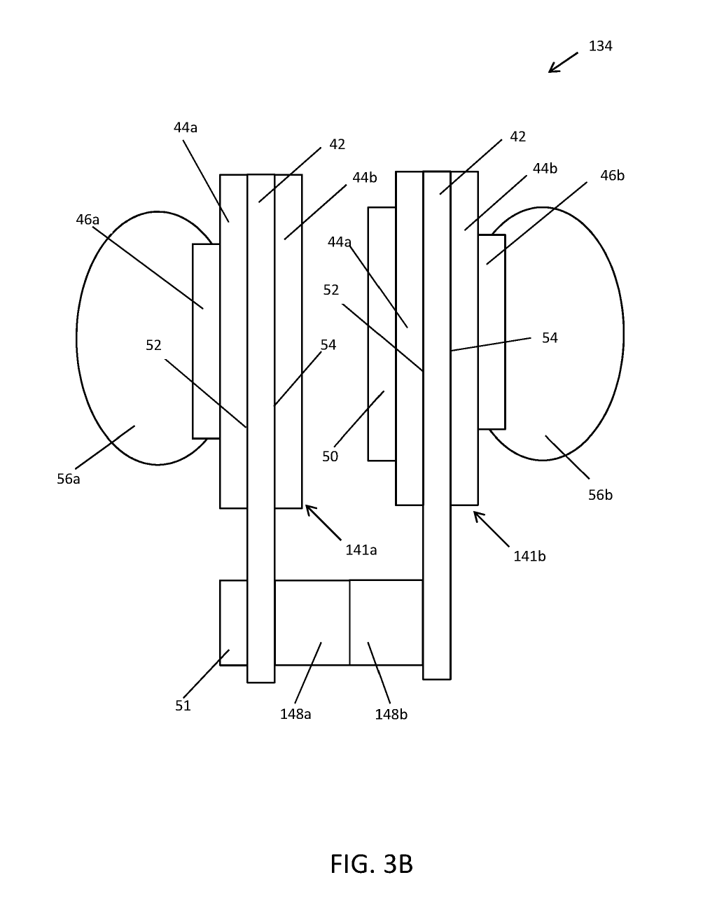

With reference to FIG. 3A, the communication node 34, 34a-n may include a printed circuit board assembly 41. The printed circuit board assembly 41 may include a substrate 42, a lateral ground plane 44a, a medial ground plane 44b, lateral antenna 46a, a medial antenna 46b, circuitry 50, and a data storage device 51. The substrate 42 may include a first side 52 and a second side 54. The lateral ground plane 44a may be disposed on the first side 52 of the substrate 42, and the medial ground plane 44b may be disposed on the second side 54 of the substrate. The lateral antenna 46a may be coupled to the lateral ground plane 44a, and the medial antenna 46b may be coupled to the medial ground plane 44b. In this regard, the substrate 42 may be disposed between the lateral and medial ground planes 44a, 44b, and the lateral and medial ground planes 44a, 44b may be disposed between the lateral and medial antennas 46a, 46b.

In some implementations, the lateral and/or medial antenna 46a, 46b may include an omnidirectional antenna. For example, the first and/or second communication nodes 34a, 34b may include an omnidirectional lateral antenna 46a and an omnidirectional medial antenna 46b. In other implementations, the lateral and/or medial antenna 46a, 46b may include a directional antenna, such as a patch antenna, for example. For example, the third and/or fourth communication nodes 34c, 34d may include a directional lateral antenna 46a and a directional medial antenna 46b. In this regard, the directional lateral antenna 46a may produce a lateral radiation pattern 56a, and the directional medial antenna 46b may produce a medial radiation pattern 56b. The lateral radiation pattern 56a may include a generally spherically-shaped radiation pattern facing a first direction, and the medial radiation pattern 56b may include a generally spherically-shaped radiation pattern facing a second direction opposite the first direction. For example, in the assembled configuration (e.g., FIGS. 1 and 2) the lateral radiation pattern 56a may face, or otherwise project in the direction of, an exterior (e.g., a surrounding environment 57) of the vehicle 12, and the medial radiation pattern 56b may face, or otherwise project in the direction of, an interior of the vehicle 12 (e.g., toward the center console 39).

The circuitry 50 may be disposed on the first and/or second side 52, 54 of the substrate 42 and may include circuitry for one or more wireless communication protocols. For example, in some implementations, the circuitry 50 includes circuitry for an ultra-high frequency (UHF) communication protocol and a BLE communication protocol. In this regard, the circuitry 50 may support one or more concurrent operations of the communication system 22. In particular, the circuitry 50 may concurrently support passively accessing and/or passively operating (e.g., passive entry passive start (PEPS)) the vehicle 12, remotely accessing (e.g., remote keyless entry (RKE)) the vehicle 12, and/or remotely communicating between the vehicle 12 and the vehicle access device 14 through BLE, for example.

The data storage device 51 may store information non-transitorily within the communication node 34, 34a-n. The data storage device 51 may be a computer-readable medium, a volatile memory unit(s), or non-volatile memory unit(s). The data storage device 51 may be physical devices used to store programs (e.g., sequences of instructions) or data (e.g., program state information) on a temporary or permanent basis for use by the system 10. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

With reference to FIG. 3B, another implementation of a communication node (e.g., one or more of the communication nodes 34, 34a-n) for use in the communication system 22 is illustrated at 134. The structure and function of the communication node 134 may be substantially similar to that of the communication node 34, apart from any exceptions described below and/or shown in FIG. 3B. Accordingly, the structure and/or function of similar features will not be described again in detail. The communication node 134 may include a first or lateral printed circuit board subassembly 141a and a second or medial printed circuit board subassembly 141b. As will be described in more detail below, the lateral printed circuit board subassembly 141a may be coupled to, or otherwise in communication with, the medial printed circuit board subassembly 141b.

The lateral printed circuit board subassembly 141a may be substantially identical to the medial printed circuit board subassembly 141b. In this regard, the lateral and medial printed circuit board subassemblies 141a, 141b may each include the substrate 42, the lateral ground plane 44a, and the medial ground plane 44b. The lateral printed circuit board subassembly 141a may include the lateral antenna 46a and a lateral printed circuit board interface 148a. The medial printed circuit board subassembly 141b may include the medial antenna 46b, circuitry 50, and a medial printed circuit board interface 148b. The lateral antenna 46a may be coupled to the lateral ground plane 44a of the lateral printed circuit board subassembly 141a, and the lateral printed circuit board interface 148a may be coupled to the second side 54 of the substrate 42 of the lateral printed circuit board subassembly 141a. The medial antenna 46b may be coupled to the medial ground plane 44b of the medial printed circuit board subassembly 141b, and the medial printed circuit board interface 148b may be coupled to the first side 52 of the substrate 42 of the medial printed circuit board subassembly 141b. In this regard, the substrate 42 may be disposed between the lateral and medial ground planes 44a, 44b, and the lateral and medial ground planes 44a, 44b may be disposed between the lateral and medial antennas 46a, 46b. The circuitry 50 may be disposed on the lateral ground plane 44b of the medial printed circuit board subassembly 141b. The lateral printed circuit board interface 148a may be coupled to the medial printed circuit board interface 148b in order to couple the lateral printed circuit board subassembly 141a to the medial printed circuit board subassembly 141b. In this regard, at least one of the lateral and medial printed circuit board interface 148a, 148b may include a board-to-board interface, a bended printed circuit board, and/or compliant pins.

In some implementations, the system 10 may implement a localization strategy using one or more of the BLE communication nodes 34a, 34b, 34c, 34d. For example, the BLE communication nodes 34a, 34b, 34c, 34d may determine a location of the vehicle access device 14 based on a received single strength indication (RSSI) value (e.g., a calibration value) corresponding to a signal received from the vehicle access device 14. In other implementations, the BLE communication nodes 34a, 34b, 34c may determine a location of the vehicle access device 14 based on at least one of (i) the RSSI value, (ii) the angle at which a signal is received by, or transmitted from, the BLE communication nodes 34a, 34b, 34c, and (iii) the time at which a signal is received by, or transmitted from, the BLE communication nodes 34a, 34b, 34c.

The infotainment system 37 may allow the vehicle 12 to communicate with the user. For example, the infotainment system 37 may include a display (not shown) and/or a speaker (not shown) that allow the infotainment system 37 to send visual and/or audible instructions to the user. In this regard, the infotainment system may be in communication with one or more of the communication nodes 34, 34a-n, the vehicle access device 14, and/or the control module 23.

The control module 23 may control various aspects of accessing and/or operating the vehicle 12. For example, in some implementations, the control module 23 may be, or otherwise include, a body control module configured to communicate with the access system 20 and/or the communication system 22 in order to permit or prevent access to the vehicle 12 through the doors 28. In some implementations, the control module 23 may be, or otherwise include, an engine control module configured to permit or prevent access to the vehicle 12 via the engine (not shown). For example, the control module 23 may permit or prevent the vehicle access device 14 from starting and/or otherwise operating the engine of the vehicle 12. The communication nodes 34, 34a-n may communicate with the control module 23 through one or more wired and/or wireless communication protocols, such as LIN Communication, CAN-FD communication, and/or K-Line communication.

The vehicle access device 14 may include a wireless communication device such as a key fob, a smartphone, a smart watch, or a computer (e.g., a tablet, laptop, personal digital assistant, etc.), for example. In this regard, while the system 10 is generally shown and described herein as including one vehicle access device 14, it will be appreciated that the system 10 may include more than one vehicle access device 14 within the scope of the present disclosure.

The vehicle access device 14 may include a power source 60, a capacitor 62, a first wireless communication node 64, a first input source or device 66a, a second input source or device 66b, a third input source or device 66c, a first antenna 68, a second wireless communication node 70, and a second antenna 72. The power source 60 may include a battery or other suitable source of electrical power. In some implementations, the power source 60 may include a coin cell battery. The capacitor 62 may be in wired or wireless communication with the power source 60. In this regard, the capacitor 62 may be wired to the power source 60 in order to selectively receive an electrical charge from the power source 60.

The first wireless communication node 64 may communicate with the capacitor 62, the first, second, and third input devices 66a, 66b, 66c, the first antenna 68, and the second wireless communication node 70. The first wireless communication node 64 may communicate through one or more wireless communication protocols, such as short-range radio wave communication, Wi-Fi, BLUETOOTH®, and/or BLE. In this regard, the first wireless communication node 64 may be referred to herein as the BLE communication node 64.

In some implementations, the first wireless communication node 64 may receive (i) power from the capacitor 62, and (i) communication (e.g., inputs) from one or more of the first, second, and third input devices 66a, 66b, 66c, the first antenna 68, and the second wireless communication node 70. In this regard, as will be explained in more detail below, the first wireless communication node 64 may receive a motion-related input from the first input device 66a, a clock signal-related input from the second and/or third input devices 66b, 66c, a user-related input from the third input device 66d, a vehicle-related input from the first antenna 68, and a vehicle-related input from the second wireless communication node 70.

The first, second, and third input devices 66a, 66b, 66c may receive input from various sources. For example, the first, second, and third input devices 66a, 66b, 66c may receive an input from one or both of the vehicle 12 and a user. As will be explained in more detail below, the first, second, and third input devices 66a, 66b, 66c may transmit, or otherwise utilize, the input to control access to and/or operation of the vehicle 12

In some implementations, the first input device 66a is a motion-related sensor such as a micro-electromechanical sensor, for example. In this regard, the first input device 66a may be configured to determine motion-related characteristics of the vehicle access device 14, such as velocity, acceleration, and/or deceleration. The first input device 66a may transmit the motion-related characteristics, and/or an input corresponding to the motion-related characteristics, to the first wireless communication node 64.

The second and third input devices 66b, 66c may each include a clock generator. For example, the second input device 66b may include a low frequency clock generator, and the third input device 66c may include a high frequency clock generator. In this regard, the second input device 66b may produce an input such as a low frequency clock signal (e.g., 32.768 kHz), and the third input device 66c may produce an input such as a high frequency clock signal (e.g., 1.0 MHz). The second and third input devices 66b, 66c may transmit the low and high frequency clock signals, respectively, to the first wireless communication node 64.

The fourth input device 66d may include a user input device. For example, the fourth input device 66d may include a touch-screen, a microphone, one or more push-buttons, or another suitable device configured to allow the user to input a command to the vehicle access device 14. In some implementations, the fourth input device 66d includes one or more push-buttons (e.g., an unlock button, a lock button, a start button, a stop button, etc.) that allow the user to input corresponding commands to the first wireless communication node 64.

The first antenna 68 may include a ceramic chip, printed circuit board, or other suitable antenna, internal to the vehicle access device 14, for transmitting a signal to, and/or receiving a signal from, the vehicle 12 and the vehicle access device 14. In some implementations, the first antenna 68 may include a BLE antenna configured to transmit a BLE signal to one or more of the BLE communication nodes 34a, 34b, 34c, 34d of the vehicle 12 from the first wireless communication node 64 of the vehicle access device 14, and to receive a BLE signal from one or more of the BLE communication nodes 34a, 34b, 34c, 34d of the vehicle 12 at the first wireless communication node 64 of the vehicle access device 14. In this regard, the BLE communication nodes 34, 34a-n of the vehicle 12 and the first wireless communication node 64 of the vehicle access device 14 may transmit and receive signals through the antennas 41, 41a-n and the first antenna 68, respectively.

The second wireless communication node 70 may communicate with the capacitor 62, the second antenna 72, and the second wireless communication node 70. The second wireless communication node 70 may communicate through one or more wireless communication protocols, such as short-range radio wave communication, Wi-Fi, BLUETOOTH®, and/or BLE. In this regard, the second wireless communication node 70 may transmit and receive low-frequency, short-range radio waves. Accordingly, the second wireless communication node 70 may be referred to herein as the LF communication node 70.

In some implementations, the second wireless communication node 70 may receive (i) power from the capacitor 62, and (i) communication (e.g., inputs) from one or more of the second antenna 72, and the first wireless communication node 64. In this regard, as will be explained in more detail below, the second wireless communication node 70 may (i) receive a signal (e.g., wake-up signal) from the first wireless communication node 64 and (ii) transmit and receive vehicle-related signals from the second antenna 72.

The second antenna 72 may include an antenna for transmitting a signal to, and/or receiving a signal from, the vehicle 12 and the vehicle access device 14. In some implementations, the second antenna 72 may include a 3D low-frequency antenna configured to transmit a low-frequency signal to the LF communication node 34e of the vehicle 12 from the second wireless communication node 70 of the vehicle access device 14, and to receive an LF signal at the second wireless communication node 70 of the vehicle access device 14 from the LF communication node 34e. In this regard, the LF communication node 34e of the vehicle 12 and the second wireless communication node 70 of the vehicle access device 14 may transmit and receive signals through the antenna 41e and the second antenna 72, respectively.

Each control center 16 may include a wireless communication node 80. In some implementations, a first of the control centers 16 may include, or otherwise define, an antenna of a vehicle sharing provider (e.g., a vehicle rental company), and a second of the control centers 16 may include, or otherwise define, an antenna of a wireless network provider (e.g., a mobile phone company). As will be explained in more detail below, the wireless communication node 80 may be configured to communicate with the vehicle 12 and/or the vehicle access device 14. For example, the wireless communication node 80 may communicate with one or more of the communication node 34, 34a-n, the wireless communication node 64, and/or the wireless communication node 70 through one or more long range wireless communication protocol, such as WIFI, LTE, a long range wide area network, or SigFox, for example, in order to determine the location of the vehicle 12.

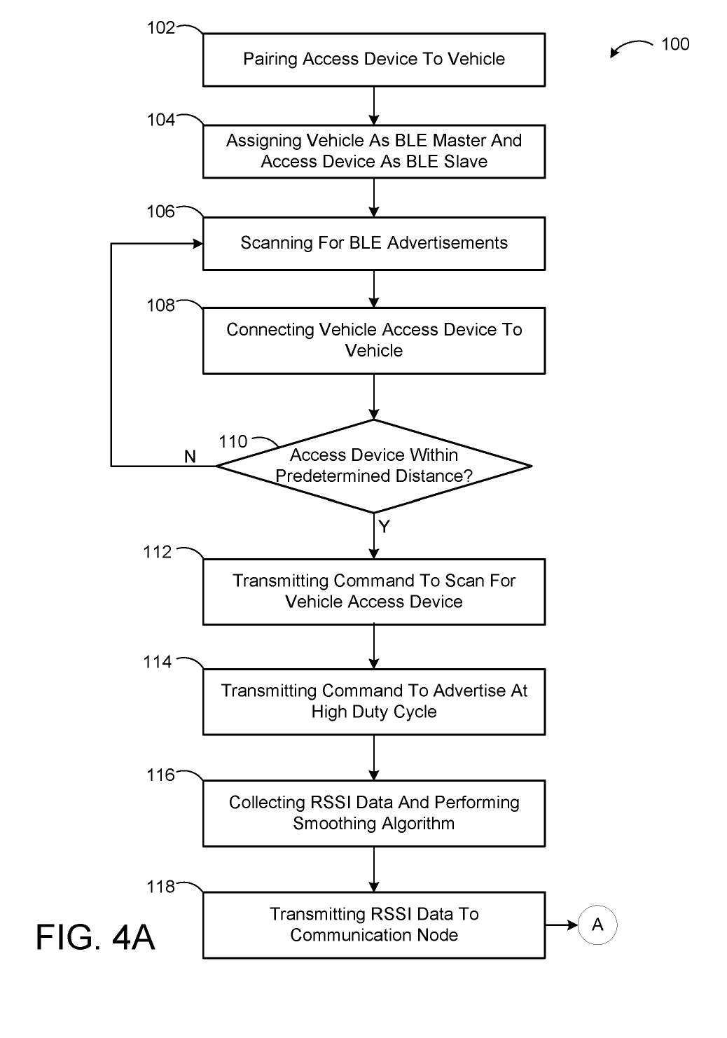

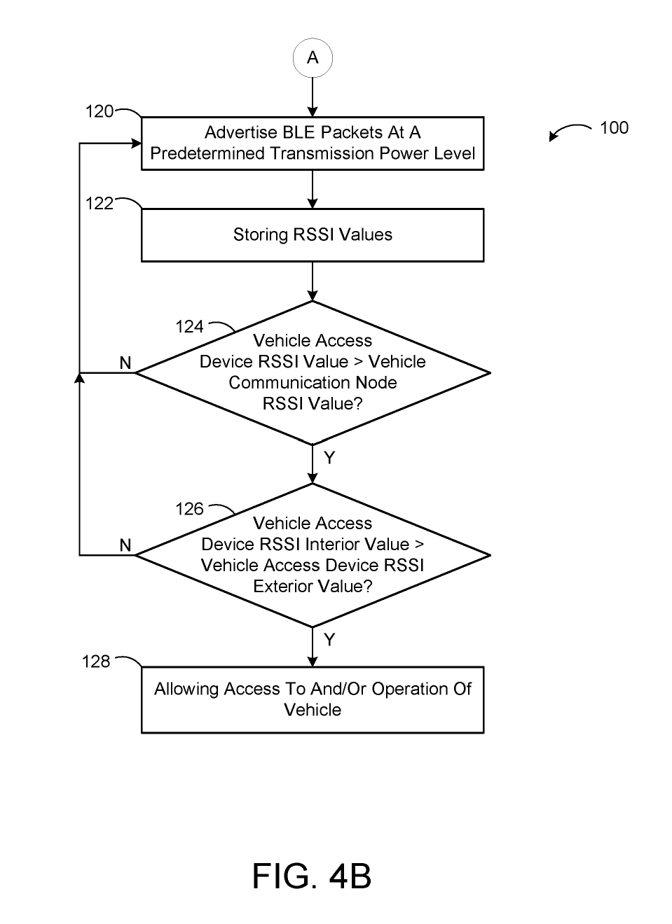

With reference to FIGS. 4A and 4B, a method for operating the system 10 is illustrated at 100. In this regard, as will be explained in more detail below, the method 100 may correspond to, or otherwise include, a localization method. For example, the method 100 may include determining the location of the vehicle access device 14 relative to the location of the vehicle 12. In particular, the method 100 may include determining whether the vehicle access device 14 is located inside or outside of the vehicle 12.

While the method 100 is generally shown and described herein relative to transmission and reception of BLE signals, the method 100 may include any transmission and reception of any suitable form of wireless signals. For example, the method 100 may include transmission and reception of WiFi signals (e.g., WiFi low power, such as WiFi 802.11ah, or WiFi Halow, for example), LTE signals (e.g., LTE-direct signals), and/or a combination of transmission and reception of BLE signals, WiFi signals, and/or LTE signals. In this regard, the transmission and reception of WiFi signals and/or LTE signals may improve the localization of the method 100 by mitigating environmental effects such as obstacles disposed between the vehicle access device 14 and one or more of the communication nodes 34, 34a-n, and by mitigating relay station attack. In some implementations, the transmission and reception of WiFi signals and/or LTE signals may support long range communication between the vehicle 12 and the vehicle access device 14. For example, the transmission and reception of WiFi signals and/or LTE signals may support communication between the vehicle 12 and the vehicle access device 14 when a distance between the vehicle 12 and the vehicle access device 14 is greater than one thousand meters.

At 102, the method 100 may include pairing, or otherwise establishing a secure connection between, the vehicle access device 14 and the vehicle 12. For example, the vehicle access device 14 and the vehicle 12 may exchange security credentials, such as identification codes, for example. In some implementations, at 102, the vehicle access device 14 may transmit security credentials (e.g., an identification code corresponding to the vehicle access device 14) to the vehicle 12, and the vehicle 12 may transmit security credentials (e.g., an identification code corresponding to the vehicle 12) to the vehicle access device 14. In this regard, the wireless communication node 64 of the vehicle access device 14 and the communication node 34a of the vehicle 12 may share and store a link key (e.g., a pass code) in order to establish a secure connection between the nodes 52, 34a. The primary communication node 34a may also share the link key with the secondary communication nodes 34b, 34c, 34d such that the secondary communication nodes 34b, 34c, 34d are securely connected to the wireless communication node 70 of the vehicle access device 14.

At 104, the method 100 may include assigning one of the vehicle 12 and the vehicle access device 14 as a central device (e.g., master) and the other of the vehicle 12 and the vehicle access device 14 as a peripheral device (e.g., slave). For example, the communication system 22 may assign the vehicle 12 as the central device (e.g., master) and the vehicle access device 14 as the peripheral device (e.g., slave). In this regard, at 104, the vehicle 12 may be assigned to (i) scan (e.g., receive) for signals (e.g., BLE advertisements, packets of wireless information, etc.) or (ii) advertise (e.g., transmit) signals (e.g., BLE advertisements, packets of wireless information, etc.), and the vehicle access device 14 may be assigned to (i) scan (e.g., receive) for signals (e.g., BLE advertisements, packets of wireless information, etc.) or (ii) advertise (e.g., transmit) signals (e.g., BLE advertisements, packets of wireless information, etc.). In some implementations, one or more of the communication nodes 34, 34a-d may be assigned to scan for advertisements transmitted from one or more other wireless communication nodes (e.g., first wireless communication node 64).

At 106, the method 100 may include scanning for advertisements with the central device. For example, at 106, the central device (e.g., one or more of the communication nodes 34, 34a-d) may scan for advertisements. In some implementations, at 106, the first communication node 34a may scan for, and receive, advertisements transmitted from the first wireless communication node 64.

At 108, the method 100 may include connecting the vehicle access device 14 to the vehicle 12. For example, at 108, the communication system 22 may wirelessly connect the vehicle access device 14 to the vehicle 12. In particular, the communication system 22 may establish a wireless connection between the first wireless communication node 64 and one of the communication nodes 34, 34a-n, and/or between the second wireless communication node 70 and the communication node 34e.

At 110, the method 100 may include determining whether the vehicle access device 14 is within a predetermined distance of the vehicle 12. For example, at 110, the communication system 22 may utilize one or more of a variety of localization methods to determine whether the vehicle access device 14 is within a detection range (e.g., less than approximately five meters) of one of the communication nodes 34, 34a-n on the vehicle 12. In this regard, at 110, the communication system 22 may determine whether the vehicle access device 14 is within three meters of the third communication node 34c. In some implementations, the communication system 22 may utilize RSSI values, angle-of-arrival, angle-of-departure, and/or time-of-flight information, corresponding to the advertisements transmitted at 104, in order to determine whether the first wireless communication node 64 of the vehicle access device 14 is within three meters of the third communication node 34c on the vehicle 12. If 110 is false, the method may return to 106. If 110 is true, the method may proceed to 112.

At 112, the method 100 may include transmitting a command to scan, or otherwise search, for the vehicle access device 14. For example, at 112, one of the communication nodes 34, 34a-n may transmit a command to another of the nodes 34, 34a-n to search for information (e.g., BLE packets) transmitted from the vehicle access device 14. In some implementations, at 112, the communication node 34a may transmit a command to one or more of the communication nodes 34b, 34c, 34d to search, or otherwise scan, for information transmitted from the vehicle access device 14.

At 114, the method 100 may include transmitting a command to advertise, or otherwise transmit, information (e.g., high duty cycle advertisements). For example, at 114, at least one of the communication nodes 34, 34a-n may transmit a command to the vehicle access device 14 to transmit high duty cycle advertisements. In some implementations, at 114, the communication node 34a may request that the first wireless transmission node 64 transmit high duty cycle advertisements. The high duty cycle advertisements can be used by the system 10, including the vehicle 12, in a localization method (e.g., RSSI, angle-of-arrival, angle-of-departure, and/or time-of-flight) in order to determine the location of the vehicle access device 14.

At 116, the method 100 may include gathering RSSI values and performing one or more smoothing algorithm. For example, at 116, one or more of the communication nodes 34, 34a-n may gather RSSI values from the first and/or second wireless transmission node 64, 70 and perform the one or more smooth algorithm. In some implementations, performing the one or more smoothing algorithm may include (i) determining which value of the gathered RSSI values occurs most frequently amongst the gathered RSSI values and (ii) determining which values of the gathered RSSI values occur less frequently than the most frequently occurring RSSI value. In this regard, performing the one or more smoothing algorithm may include removing from the gathered RSSI values the RSSI value that occur less frequently than the most frequently occurring RSSI value. In particular, performing the one or more smoothing algorithm may include removing high and/or low outlier RSSI values from the gathered RSSI values to produce smoothed RSSI values.

At 118, the method 100 may include transmitting RSSI values from one or more of the communication nodes 34, 34a-n to one or more others of the communication nodes 34, 34a-n. For example, at 118, the communication node 34c may transmit the smoothed RSSI values, corresponding to the smoothed RSSI values of the first and/or second wireless transmission node 64, 70, to the communication node 34a and/or to the communication node 34b. In some implementations, communication node 34c may transmit RSSI values, corresponding to the communication node 34c, to the communication node 34b. The one or more of the communication nodes 34, 34a-n may transmit the RSSI values to the one or more other communication nodes 34, 34a-n using a wireless (e.g., mesh, scatternet, etc.) or wired (e.g., CAN, LIN, K-Line, etc.) communication protocol.

At 120, the method 100 may include advertising, or otherwise transmitting, information at a predetermined power level from one or more of the communication nodes 34, 34a-n. For example, at 120, the communication node 34c may transmit a BLE packet at a power level T34c. The first wireless communication node 64 may transmit a BLE packet at a power level T64 The transmit power level T34c may be substantially equal to the transmit power level T64. The transmission of information at the power level T34c, substantially equal to the power level power level T64c, can improve the accuracy of the smoothed RSSI values and of the localization of the vehicle access device 14. If the system 10 includes more than one vehicle access device 14, the transmit power level T34c may be substantially equal to the transmit power level T64 of the first wireless communication node 64 of each vehicle access device 14.

At 122, the method 100 may include storing RSSI values. For example, at 122, the communication system 22 may store the smoothed RSSI values within one or more of the communication nodes 34, 34a-n. In some implementations, at 122, the communication system 22 may store the smoothed RSSI values within the data storage device 51 of the communication node 34b and within the data storage device 51 of the communication node 34a.

At 124, the method 100 may include comparing an RSSI value corresponding to the vehicle access device 14 to an RSSI value corresponding to one or more of the communication nodes 34, 34a-n. For example, at 124, the communication system 22 may compare (i) an RSSI value corresponding to the first and/or second wireless transmission node 64, 70 to (ii) an RSSI value corresponding to the communication node 34c. In some implementations, at 124, the communication system 22 may determine a difference between the RSSI value corresponding to the first and/or second wireless transmission node 64, 70 and the RSSI value corresponding to the communication node 34c. In particular, at 124, the communication system may determine whether the RSSI value corresponding to the first and/or second wireless transmission node 64, 70 is greater than an RSSI value corresponding to the communication node 34c. In particular, the communication system 22 may determine whether the RSSI value corresponding to the first and/or second wireless transmission node 64, 70 is greater than the RSSI value corresponding to the directional medial antenna 46b of one of the communication nodes 34, 34a-n (e.g., communication node 34c). In this regard, the communication system 22 may determine whether the RSSI value corresponding to the first and/or second wireless transmission node 64, 70 is greater than the RSSI value corresponding to the medial radiation pattern 56b projecting in the direction of the interior of the vehicle 12. If the RSSI value corresponding to the first and/or second wireless transmission node 64, 70 is less than or equal to the RSSI value corresponding to the directional medial antenna 46b, the method 100 may return to 120. If the RSSI value corresponding to the first and/or second wireless transmission node 64, 70 is greater than the RSSI value corresponding to the directional medial antenna 46b, the method 100 may proceed to 126.

At 126, the method 100 may include comparing (i) the RSSI value corresponding to the vehicle access device 14, as determined by one or more of the communication nodes 34, 34a-n, to (ii) the RSSI value corresponding to the vehicle access device 14, as determined by the one or more of the communication nodes 34, 34a-n. In particular, at 126, the communication system 22 may determine a difference between the RSSI value corresponding to the vehicle access device 14, as determined by one or more of the communication nodes 34, 34a-n, and the RSSI value corresponding to the vehicle access device 14, as determined by the one or more of the communication nodes 34, 34a-n. For example, at 124, the communication system 22 may determine whether the RSSI value corresponding to the first and/or second wireless transmission node 64, 70, as such RSSI value is determined by the directional medial antenna 46b of the communication node 34c, is greater than the RSSI value corresponding to the first and/or second wireless transmission node 64, 70, as such RSSI value is determined by the directional lateral antenna 46a of the communication node 34c. In this regard, at 126, the communication system 22 may determine whether (i) the RSSI value corresponding to the first and/or second wireless transmission node 64, 70, as such RSSI value is determined, or otherwise received by, the medial radiation pattern 56b of the communication node 34c, is greater than (ii) the RSSI value corresponding to the first and/or second wireless transmission node 64, 70, as such RSSI value is determined, or otherwise received by, the lateral radiation pattern 56a of the communication node 34c.

If (i) the RSSI value corresponding to the first and/or second wireless transmission node 64, 70, as such RSSI value is determined, or otherwise received by, the medial radiation pattern 56b of the communication node 34c, is greater than (ii) the RSSI value corresponding to the first and/or second wireless transmission node 64, 70, as such RSSI value is determined, or otherwise received by, the lateral radiation pattern 56a of the communication node 34c, the method 100 may proceed to 128. If (i) the RSSI value corresponding to the first and/or second wireless transmission node 64, 70, as such RSSI value is determined, or otherwise received by, the medial radiation pattern 56b of the communication node 34c, is less than or equal to (ii) the RSSI value corresponding to the first and/or second wireless transmission node 64, 70, as such RSSI value is determined, or otherwise received by, the lateral radiation pattern 56a of the communication node 34c, the method 100 may return to 120.

At 128, the method 100 may include allowing access to, and/or operation of, the vehicle 12. For example, at 128, the communication system 22 may transmit a signal to the access system 20 and/or the control module 23 allowing a vehicle operator (e.g., a driver) to start the engine of the vehicle 12. In some implementations, the communication system 22 may communicate with the control module 23 in order to permit the vehicle operator to start the engine of the vehicle 12. In some implementations, the communication system 22 may communicate with the access system 20 in order to permit the vehicle operator to access the vehicle 12.

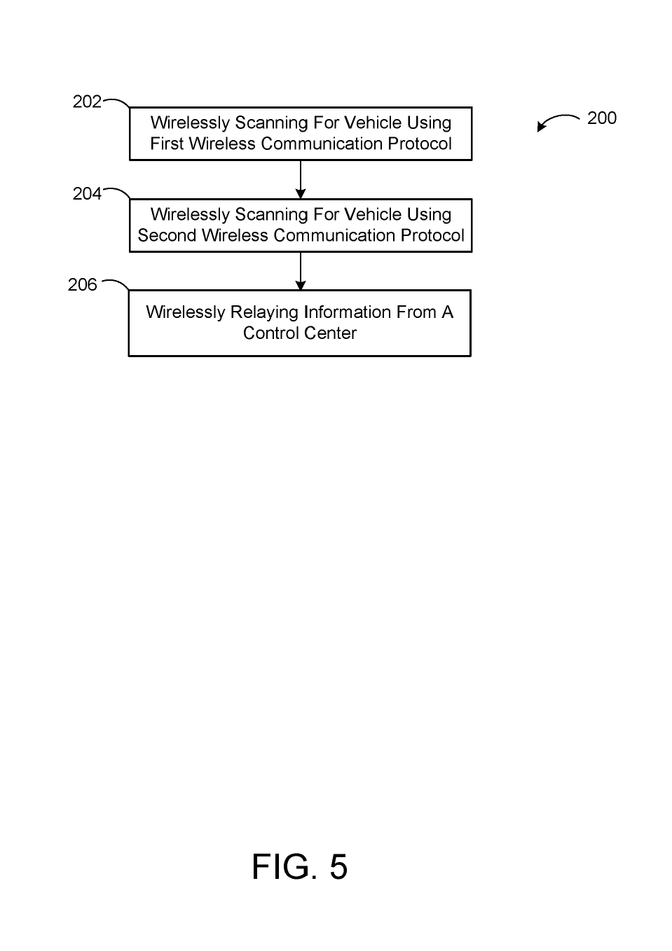

With reference to FIG. 5, a method for operating the system 10 is illustrated at 200. In this regard, as will be explained in more detail below, the method 200 may correspond to, or otherwise include, a localization method. For example, the method 200 may include determining the location of the vehicle 12 relative to the location of the control center 16.

At 202, the method 200 may include wirelessly scanning, or otherwise searching, for the vehicle 12. For example, at 202, the control center 16 may wirelessly search for signals transmitted from the vehicle 12. In some implementations, the communication node 80 may search for signals transmitted from one or more of the communication nodes 34, 34a-n. In this regard, the communication node 80 may search for signals transmitted from one or more of the communication nodes 34, 34a-n using a first wireless communication protocol. For example, the communication node 80 may search for signals transmitted through a cellular network from one or more of the communication nodes 34, 34a-n.

At 204, the method may include wirelessly scanning, or otherwise searching, for the vehicle 12. For example, at 204, the control center 16 may wirelessly search for signals transmitted from the vehicle 12. In some implementations, the communication node 80 may search for signals transmitted from one or more of the communication nodes 34, 34a-n. In this regard, the communication node 80 may search for signals transmitted from one or more of the communication nodes 34, 34a-n using a second wireless communication protocol. In particular, the communication node 80 may search for signals transmitted from one or more of the communication nodes 34, 34a-n if the communication node 80, at 202, did not receive a signal from one or more of the communication nodes 34, 34a-n. The second wireless communication protocol may be different than the first wireless communication protocol. For example, at 204, the communication node 80 may search for signals transmitted through a long range wide area network or a SigFox from one or more of the communication nodes 34, 34a-n.

At 206, the method may include wirelessly transmitting information corresponding to the signals received at 204 from the control center 16. For example, the communication node 80 may transmit information corresponding to the signals received at 204 from the control center 16 to another location corresponding to the vehicle sharing provider (e.g., a vehicle rental company).

The following Clauses provide an exemplary configuration for an article of footwear described above.

Clause 1: A method comprising determining a first received signal strength indicator value, determining a second received signal strength indicator value, determining a third received signal strength indicator value, determining a first difference between the first received signal strength indicator value and the second received signal strength indicator value, determining a second difference between the first received signal strength indicator value and the third received signal strength indicator value, and transmitting a signal based on the first difference and the second difference.

Clause 2: The method of Clause 1, wherein the first received signal strength indicator value corresponds to a vehicle access device.

Clause 3: The method of Clause 2, wherein the second received signal strength indicator value corresponds to a vehicle.

Clause 4: The method of Clause 3, wherein the third received signal strength indicator value corresponds to the vehicle access device.

Clause 5: The method of Clause 1, wherein determining the first received signal strength indicator value includes determining the first received signal strength indicator value at a first antenna.

Clause 6: The method of Clause 5, wherein determining the third received signal strength indicator value includes determining the third received signal strength indicator value at a second antenna.

Clause 7: The method of Clause 6, wherein the first antenna faces a first direction and the second antenna faces a second direction transverse to the first direction.

Clause 8: The method of Clause 7, wherein the first direction is opposite the second direction.

Clause 9: The method of Clause 7, wherein the first antenna includes a directional antenna.

Clause 10: The method of Clause 1, wherein at least one of the first, second, and third received signal strength indicator values corresponds to a BLUETOOTH® low energy signal.

Clause 11: A wireless communication node for a vehicle, the wireless communication node comprising a substrate having a first side and a second side opposite the first side, a first ground plane disposed on the first side, a second ground plane disposed on the second side, a first antenna coupled to the first ground plane and operable to produce a first radiation pattern, and a second antenna coupled to the second ground plane and operable to produce a second radiation pattern.

Clause 12: The wireless communication node of Clause 11, wherein the first radiation pattern corresponds to a wireless signal selected from the group consisting of a BLUETOOTH® low energy signal, a WiFi signal, and a Long-Term Evolution signal.

Clause 13: The wireless communication node of Clause 11, wherein the first radiation pattern is operable to face an exterior portion of the vehicle and the second radiation pattern is operable to face an interior portion of the vehicle.

Clause 14: The wireless communication node of Clause 11, wherein the first antenna includes a directional antenna.

Clause 15: The wireless communication node of Clause 14, wherein the second antenna includes a directional antenna.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method comprising:
determining a first received signal strength indicator value;
determining a second received signal strength indicator value;
determining a third received signal strength indicator value;
determining a first difference between the first received signal strength indicator value and the second received signal strength indicator value;
determining a second difference between the first received signal strength indicator value and the third received signal strength indicator value; and
transmitting a signal based on the first difference and the second difference.

2. The method of claim 1, wherein the first received signal strength indicator value corresponds to a vehicle access device.

3. The method of claim 2, wherein the second received signal strength indicator value corresponds to a vehicle.

4. The method of claim 3, wherein the third received signal strength indicator value corresponds to the vehicle access device.

5. The method of claim 1, wherein determining the first received signal strength indicator value includes determining the first received signal strength indicator value at a first antenna.

6. The method of claim 5, wherein determining the third received signal strength indicator value includes determining the third received signal strength indicator value at a second antenna.

7. The method of claim 6, wherein the first antenna faces a first direction and the second antenna faces a second direction transverse to the first direction.

8. The method of claim 7, wherein the first direction is opposite the second direction.

9. The method of claim 7, wherein the first antenna includes a directional antenna.

10. The method of claim 1, wherein at least one of the first, second, and third received signal strength indicator values corresponds to a BLUETOOTH® low energy signal.

11. A wireless communication node for a vehicle, the wireless communication node comprising:
a substrate having a first side and a second side opposite the first side;
a first ground plane disposed on the first side;
a second ground plane disposed on the second side;
a first antenna coupled to the first ground plane and operable to produce a first radiation pattern; and
a second antenna coupled to the second ground plane and operable to produce a second radiation pattern.

12. The wireless communication node of claim 11, wherein the first radiation pattern corresponds to a wireless signal selected from the group consisting of a BLUETOOTH® low energy signal, a WiFi signal, and a Long-Term Evolution signal.

13. The wireless communication node of claim 11, wherein the first radiation pattern is operable to face an exterior portion of the vehicle and the second radiation pattern is operable to face an interior portion of the vehicle.

14. The wireless communication node of claim 11, wherein the first antenna includes a directional antenna.

15. The wireless communication node of claim 14, wherein the second antenna includes a directional antenna.
